(19) United States
(12) Patent Application Publication
(10) Pub. No.: US 2018/0124691 A1
(43) Pub. Date: May 3, 2018

(54) METHOD AND APPARATUS FOR ACCESSING WIRELESS NETWORK WITH SMART DEVICE

(71) Applicant: BEIJING XIAOMI MOBILE SOFTWARE CO., LTD., Beijing (CN)

(72) Inventors: Enxing HOU, Beijing (CN); Yanlu ZHANG, Beijing (CN)

(73) Assignee: BEIJING XIAOMI MOBILE SOFTWARE CO., LTD., Beijing (CN)

(21) Appl. No.: 15/796,269

(22) Filed: Oct. 27, 2017

(30) Foreign Application Priority Data
Oct. 31, 2016 (CN) 201610967608.0

(51) Int. Cl. H04W 48/16; H04W 12/06

(52) U.S. Cl. CPC H04W 48/16; H04W 12/06

(57) ABSTRACT

The disclosure relates to a method for accessing a wireless network with a first device. The method includes scanning for a first service set identification (SSID); acquiring the first SSID from a scan result, wherein a second device corresponding to the first SSID is connected with the wireless network and provided with an activated relay function; accessing the second device based on the first SSID and a first password of the second device; acquiring a second SSID and a second password of the wireless network from the second device; and accessing the wireless network based on the second SSID and the second password.

### CROSS-REFERENCE TO RELATED APPLICATIONS

This application is based on and claims priority to Chinese Patent Application No. 201610967608.0, filed on Oct. 31, 2016, the entire contents of which are incorporated herein by reference.

### TECHNICAL FIELD

The present disclosure relates to the field of communication, and more particularly, to a method and an apparatus for accessing a wireless network with a smart device.

### BACKGROUND

When a smart device accesses a router through wireless fidelity (referred to as Wi-Fi) technology, a user is generally required to enter a service set identifier (referred to as SSID) and a password of the router through a keypad, a touch screen or the like. The above process may be implemented by some devices having input means, such as mobile phones, tablet PCs and the like, but cannot be used by those devices without input means to access the router.

### SUMMARY

This Summary is provided to introduce a selection of aspects of the present disclosure in a simplified form that are further described below in the Detailed Description. This Summary is not intended to identify key features or essential features of the claimed subject matter, nor is it intended to be used to limit the scope of the claimed subject matter.

Aspects of the disclosure provide a method for accessing a wireless network with a first device. The method includes scanning for a first service set identification (SSID); acquiring the first SSID from a scan result, wherein a second device corresponding to the first SSID is connected with the wireless network and provided with an activated relay function; accessing the second device based on the first SSID and a first password of the second device; acquiring a second SSID and a second password of the wireless network from the second device; and accessing the wireless network based on the second SSID and the second password.

Scanning for the first SSID includes scanning access points to obtain the scan result including SSIDs of the access points; determining whether the first SSID is present in the scan result; and acquiring the first SSID when the first SSID is present in the scan result.

Acquiring the second SSID and the second password of the wireless network from the second device includes sending a request message to the second device for acquiring the second SSID and the second password of the wireless network; and receiving a response message from the second device, the response message including the second SSID and the second password of the wireless network.

Acquiring the second SSID and the second password of the wireless network from the second device includes receiving the second SSID and the second password of the wireless network in a message generated by the second device.

Aspects of the disclosure provide an apparatus for accessing a wireless network with a first device. The apparatus includes a processor and a memory configured to store instructions executable by the processor. The processor is configured to scan for a first service set identification (SSID); acquire the first SSID from a scan result, wherein a second device corresponding to the first SSID is connected with the wireless network and provided with an activated relay function; access the second device based on the first SSID and a first password of the second device; acquire a second SSID and a second password of the wireless network from the second device; and access the wireless network based on the second SSID and the second password.

The processor is also configured to scan access points to obtain the scan result including SSIDs of the access points; determine whether the first SSID is present in the scan result; and acquire the first SSID when the first SSID is present in the scan result.

The processor is also configured to send a request message to the second device for acquiring the second SSID and the second password of the wireless network; and receive a response message from the second device, the response message including the second SSID and the second password of the wireless network.

The processor is also configured to receive the second SSID and the second password of the wireless network in a message generated by the second device.

Aspects of the disclosure also provide a non-transitory computer-readable storage medium having stored therein instructions. The instructions, when executed by one or more processors of a first device, cause the first device to scan for a first service set identification (SSID); acquire the first SSID from a scan result, wherein a second device corresponding to the first SSID is connected with the wireless network and provided with an activated relay function; access the second device based on the first SSID and a first password of the second device; acquiring a second SSID and a second password of the wireless network from the second device; and accessing the wireless network based on the second SSID and the second password.

It is to be understood that both the foregoing general description and the following detailed description are exemplary and explanatory only and are not restrictive of the present disclosure.

### BRIEF DESCRIPTION OF THE DRAWINGS

The accompanying drawings, which are incorporated in and constitute a part of this specification, illustrate aspects consistent with the present disclosure and, together with the description, serve to explain the principles of the present disclosure.

FIG. 1 is a flowchart illustrating a method for accessing a wireless network with a smart device according to an exemplary aspect of the present disclosure.

FIG. 2 is a flowchart illustrating a method for accessing a wireless network with a smart device according to an exemplary aspect of the present disclosure.

FIG. 3 is a block diagram illustrating an apparatus for accessing a wireless network with a smart device according to an exemplary aspect of the present disclosure.

FIG. 4 is a block diagram illustrating an apparatus for accessing a wireless network with a smart device according to an exemplary aspect of the present disclosure.

FIG. 5 is a block diagram illustrating an apparatus for accessing a wireless network with a smart device according to an exemplary aspect of the present disclosure.

FIG. 6 is a block diagram illustrating an apparatus for accessing a wireless network with a smart device according to an exemplary aspect of the present disclosure.

FIG. 7 is an exemplified block diagram illustrating an apparatus for accessing a wireless network with a smart device according to an exemplary aspect of the present disclosure.

The specific aspects of the present disclosure, which have been illustrated by the accompanying drawings described above, will be described in detail below. These accompanying drawings and description are not intended to limit the scope of the present disclosure in any manner, but to explain the concept of the present disclosure to those skilled in the art via referencing specific aspects.

### DETAILED DESCRIPTION

Hereinafter, exemplary aspects will be described in detail, examples of which are shown in the drawings. In the following description when referring to the drawings, the same numerals in the different drawings denote the same or similar elements unless otherwise indicated. The aspects described in the following exemplary aspects are not representative of all aspects consistent with the present disclosure. Rather, they are merely examples of devices and methods consistent with some aspects of the disclosure as detailed in the appended claims.

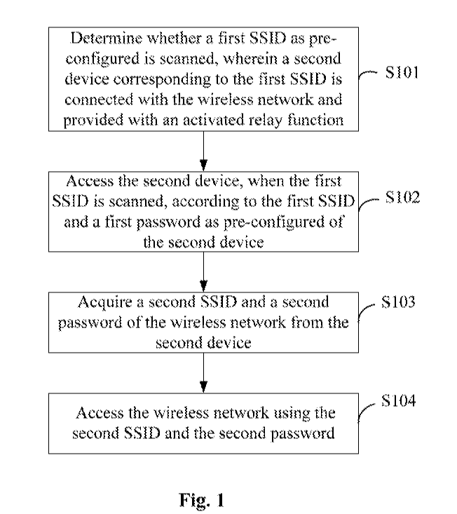

FIG. 1 is a flowchart illustrating a method for accessing a wireless network with a smart device according to an exemplary aspect. The method in the present aspect may be implemented by a first device. As shown in FIG. 1, the method for accessing a wireless network with a smart device includes following steps.

In steps S101, it is determined whether a first SSID as pre-configured is scanned, wherein a second device corresponding to the first SSID is connected with the wireless network and provided with an activated relay function.

In the present aspect, the first device is not provided with input means, such as a keyboard, a touch screen, and the like. The first device may be a smart device having no input means, such as a smart desk lamp, a smart socket, a smart purifier, and a smart keyboard. Since the first device is not provided with input means, a user cannot access a wireless network by entering an SSID and a password of the wireless network as doing with a device provided with input means.

In order to solve the problem that the first device cannot access the wireless network, a second device is pre-configured for the first device in the present aspect. For example, a first SSID and a first password of the second device are prestored in the first device. The second device, which may be a mobile phone, a tablet computer, and the like, is provided with input means, and has a relay function in addition to normal functions when serving as a station (STA). As the second device has the relay function, it can serve as an access point having a first SSID and a first password that are fixed. Accordingly, when the first device without input means needs to access the wireless network, it may first access the second device using the first SSID and the first password of the second device as pre-configured, so as to obtain the second SSID and the second password of the wireless network through the second device.

The first device may scan its surrounding access points by active scanning or passive scanning. The active scanning may be performed by actively searching for the wireless network, rather than waiting for the presence statement from the wireless network itself. In an aspect, the active scanning is performed by issuing a probe request on each channel from the first device serving as the STA, so as to request response from surrounding wireless network. On the other hand, power consumption can be saved by the passive scanning since no signal needs to be transmitted by the first device during the scanning. In the passive scanning, the STA switches between respective channels listed in a channel list so as to monitor arrival of a Beacon frame.

The scan result obtained by the first device may include SSIDs, signal quality, encryption and authentication modes of multiple access points. Accordingly, the first device may determine whether the first SSID is included in the scan result, and if the first SSID is included in the scan result, the first device determines that the first SSID and, thus, the second device are scanned. If the first SSID is not included in the scan result, it indicates that the second device does not have access to any network device, so it is impossible for the first device to obtain the second SSID and the second password of the wireless network through the second device, and access failure information may be prompted to the user.

In step S102, the second device is accessed, when the first SSID is scanned, according to the first SSID and a first password as pre-configured of the second device.

As the first SSID and the first password of the second device are pre-configured in the first device, if the first SSID is scanned by the first device, it indicates that the first device can access the second device. Accordingly, the first device may access the second device according to the first SSID and the first password of the second device that are pre-configured.

In step S103, a second SSID and a second password of the wireless network are acquired from the second device.

In an aspect, after the first device accesses the second device, the first device sends a request message to the second device for requesting the second SSID and the second password of the wireless network. Then the second device returns a request response to the first device based on the request message. Accordingly, the first device receives the request response sent by the second device, which carries the second SSID and the second password of the wireless network.

In another aspect, after the first device accesses the second device, the second device actively reports the second SSID and the second password of the wireless network to the first device. In this way, the first device receives the second SSID and the second password of the wireless network reported by the second device.

In step S104, the wireless network is accessed using the second SSID and the second password.

In a home network, for example, the first device may be a mobile phone, which accesses to a router in a typical manner and is provided with a first SSID and a first password that are fixed. Then, when same series of products, such as a smart socket, a smart purifier and a smart keyboard, are bought by the user, they may be configured with the first SSID and the first password of the mobile phone. Accordingly, the smart socket, smart purifier and smart keyboard may have access to the mobile phone using the first SSID and the first password of the mobile phone, so as to acquire the second SSID and the second password of the wireless network through the mobile phone and, then, access the wireless network according to the second SSID and the second password thereof.

According to the present aspect, the second device having the relay function is provided, and the first SSID and the first password of the second device is configured in advance within the first device without input means. When the first device needs to access the wireless network, it is determined whether the first SSID is scanned. Then, the first device may access, when the first SSID is scanned, the second device according to the first SSID and the first password thereof as pre-configured; acquire the second SSID and the second password of the wireless network from the second device; and access the wireless network using the second SSID and the second password. According to the method, a device without input means is able to access the wireless network.

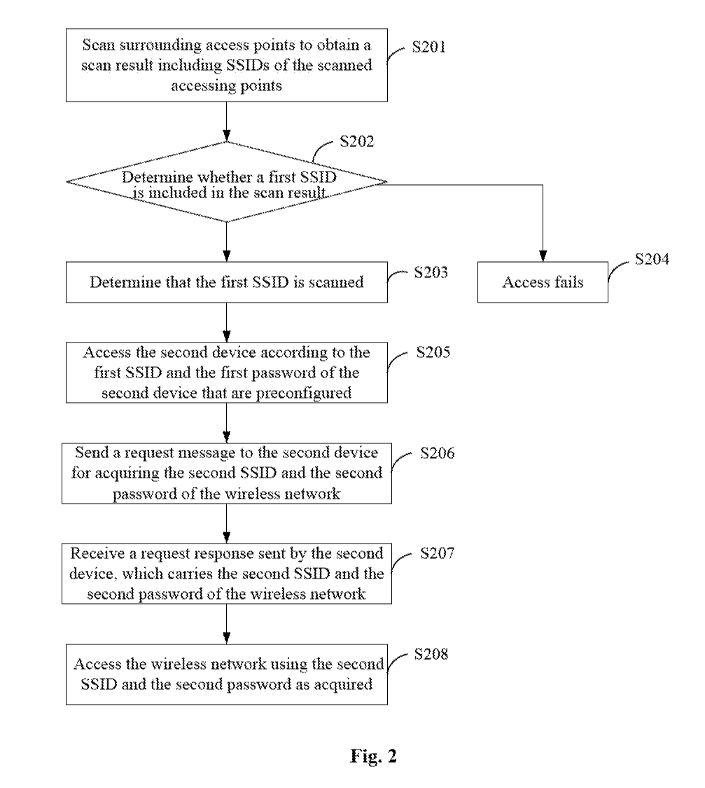

FIG. 2 is a flowchart illustrating a method for accessing a wireless network with a smart device according to an exemplary aspect. As shown in FIG. 2, the method for accessing a wireless network with a smart device includes following steps.

In step S201, surrounding access points are scanned to obtain a scan result including SSIDs of the scanned accessing points.

In step S202, it is determined whether a first SSID is included in the scan result.

In addition to SSIDs of the accessing points, the scan result may also include other parameters such as a signal strength of each access point. Moreover, the first SSID and the first password of the second device are pre-configured in the first device, when the first SSID is included in the scan result, step S203 is performed; and when the first SSID is not included in the scan result, step S204 is performed.

In step S203, it is determined that the first SSID is scanned.

In step S204, access fails.

In step S205, the second device is accessed according to the first SSID and the first password of the second device that are pre-configured.

Step S205 may be performed after step S203.

In step S206, a request message is sent to the second device for acquiring the second SSID and the second password of the wireless network.

In step S207, a request response sent by the second device is received, which carries the second SSID and the second password of the wireless network.

In step S208, the wireless network is accessed using the second SSID and the second password as acquired.

Alternatively, in another aspect, after the first device accesses the second device, the second SSID and the second password of the wireless network may be also actively sent by the second device without sending request from the first device.

Specific implementation of the present aspect may also refer to related description of the first aspect and, thus, will not be elaborated herein.

According to the present aspect, the first device scans its surrounding access points and determines whether the first SSID of the second device is included in the scan result. When the first SSID is included in the scan result, the first device accesses the second device according to the first SSID and the first password that are pre-configured, sends the request message to the second device, receives the request response carrying the second SSID and the second password of the wireless network from the second device, and accesses the wireless network using the second SSID and the second password. According to the method, a device without input means is able to access the wireless network.

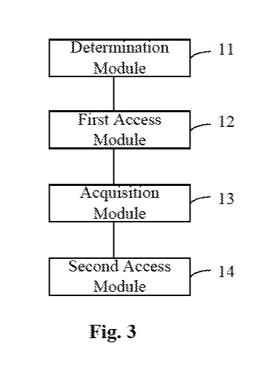

FIG. 3 is a block diagram illustrating an apparatus for accessing a wireless network with a smart device according to an exemplary aspect. As shown in FIG. 3, the apparatus in this aspect includes: a determination module 11, a first access module 12, an acquisition module 13 and a second access module 14.

In an aspect, the determination module 11 is configured to determine whether a first service set identification SSID as pre-configured is scanned. Herein, a second device corresponding to the first SSID is connected with the wireless network and provided with an activated relay function.

The first access module 12 is configured to access, when the first SSID is scanned, the second device according to the first SSID and a first password as pre-configured of the second device.

The acquisition module 13 is configured to acquire a second SSID and a second password of the wireless network from the second device.

The second access module 14 is configured to access the wireless network using the second SSID and the second password.

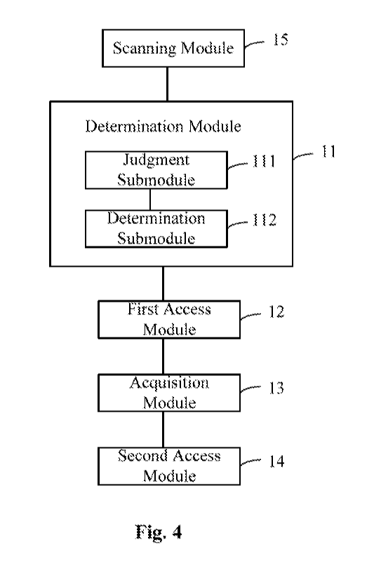

FIG. 4 is a block diagram illustrating an apparatus for accessing a wireless network with a smart device according to an exemplary aspect. As shown in FIG. 4, the apparatus in this aspect includes, in addition to the apparatus as shown in FIG. 3, a scanning module 15, and the determination module 11 further includes a judgment submodule 111 and a determination submodule 112.

The scanning module 15 is configured to scan surrounding access points to obtain a scan result comprising SSIDs of the scanned access points.

The judgment submodule 111 is configured to determine whether the first SSID is present in the scan result.

The determination submodule 112 is configured to determine, when the first SSID is present in the scan result, the first SSID is scanned.

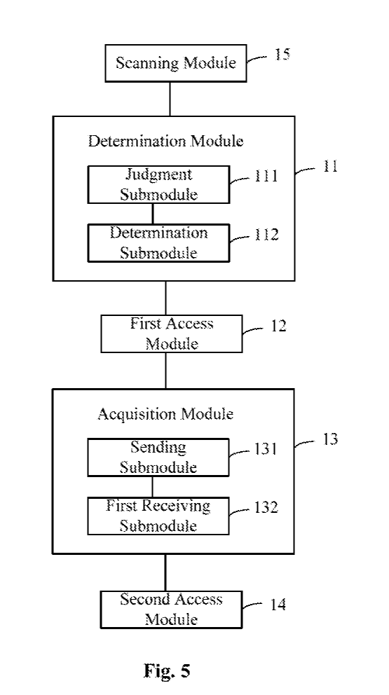

FIG. 5 is a block diagram illustrating an apparatus for accessing a wireless network with a smart device according to an exemplary aspect. As shown in FIG. 5, in addition to the apparatus as shown in FIG. 4, the acquisition module 13 further includes:

a sending submodule 131 configured to send a request message to the second device for acquiring the second SSID and the second password of the wireless network; and

a first receiving submodule 132 configured to receive a request response sent by the second device, the request response carrying the second SSID and the second password of the wireless network.

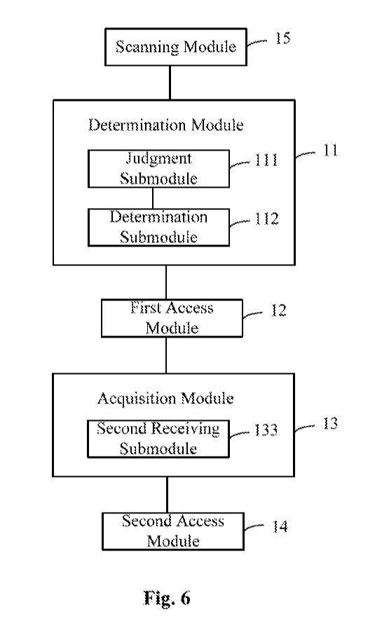

FIG. 6 is a block diagram illustrating an apparatus for accessing a wireless network with a smart device according to an exemplary aspect. As shown in FIG. 6, in addition to the apparatus as shown in FIG. 4, the acquisition module 13 further includes:

a second receiving submodule 133 configured to receive the second SSID and the second password of the wireless network reported by the second device.

With respect to the apparatus in the above aspect, the specific mode in which each module and the submodule performs the operation has been described in detail in the aspect shown by FIGS. 1 and 2 relating to the method, and the description thereof will not be described in detail herein.

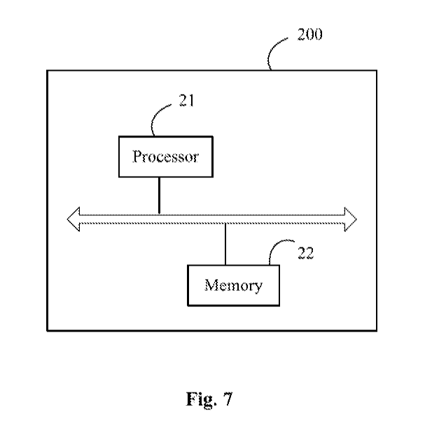

FIG. 7 is an exemplified block diagram illustrating an apparatus for accessing a wireless network with a smart device according to an exemplary aspect. As shown in FIG. 7, the apparatus 200 for accessing a wireless network with a smart device includes a processor 21 and a memory 22 configured to store instructions executable by the processor 21. Herein, the memory 22 is connected to and communicates with the processor 21 through a system bus.

In an aspect, the processor 21 is configured to:

determine whether a first SSID as pre-configured is scanned, wherein a second device corresponding to the first SSID is connected with the wireless network and provided with an activated relay function:

access, when the first SSID is scanned, the second device according to the first SSID and a first password as pre-configured of the second device;

acquire a second SSID and a second password of the wireless network from the second device; and

access the wireless network using the second SSID and the second password.

In the aspect of the above-described recharge device, it is to be understood that the processor may be a Central Processing Unit abbreviation: CPU), and may be other general-purpose processors, Digital Signal Processor (referred to as DSP), Application Specific Integrated Circuit (referred to as ASIC) and so on. The general-purpose processor may be a microprocessor or a conventional processor, etc. The memory may be a read-only memory (ROM), a random access memory (read-only memory, referred to as RAM), flash memory, hard disk or solid state disk. The steps of the method disclosed in connection with the aspects of the present disclosure may be embodied directly in the execution of the hardware processor or by the combination of hardware and software modules in the processor.

It is noted that the various modules, sub-modules, units, and components in the present disclosure can be implemented using any suitable technology. For example, a module may be implemented using circuitry, such as an integrated circuit (IC). As another example, a module may be implemented as a processing circuit executing software instructions.

Other aspects of the disclosure will be apparent to those skilled in the art from consideration of the specification and practice of the disclosure disclosed here. The present disclosure is intended to cover any variations, uses, or adaptations of the disclosure following the general principles thereof and including such departures from the present disclosure as come within known or customary practice in the art. It is intended that the specification and examples be considered as exemplary only, with a true scope and spirit of the disclosure being indicated by the following claims.

It is to be understood that the disclosure is not limited to the precise constructions described above and shown in the accompanying drawings, and that various modifications and changes may be made without departing from the scope thereof. The scope of the disclosure is limited only by the appended claims.

What is claimed is:

1. A method for accessing a wireless network with a first device, comprising:
scanning for a first service set identification (SSID);
acquiring the first SSID from a scan result, wherein a second device corresponding to the first SSID is connected with the wireless network and provided with an activated relay function;
accessing the second device based on the first SSID and a first password of the second device;
acquiring a second SSID and a second password of the wireless network from the second device; and
accessing the wireless network based on the second SSID and the second password.

2. The method of claim 1, wherein scanning for the first SSID comprises:
scanning access points to obtain the scan result including SSIDs of the access points;
determining whether the first SSID is present in the scan result; and
acquiring the first SSID when the first SSID is present in the scan result.

3. The method of claim 1, wherein acquiring the second SSID and the second password of the wireless network from the second device comprises:
sending a request message to the second device for acquiring the second SSID and the second password of the wireless network; and
receiving a response message from the second device, the response message including the second SSID and the second password of the wireless network.

4. The method of claim 1, wherein acquiring the second SSID and the second password of the wireless network from the second device comprises:
receiving the second SSID and the second password of the wireless network in a message generated by the second device.

5. An apparatus for accessing a wireless network with a first device, comprising:
a processor; and
a memory configured to store instructions executable by the processor,
wherein the processor is configured to:
scan for a first service set identification (SSID);
acquire the first SSID from a scan result, wherein a second device corresponding to the first SSID is connected with the wireless network and provided with an activated relay function;
access the second device based on the first SSID and a first password of the second device;
acquire a second SSID and a second password of the wireless network from the second device; and
access the wireless network based on the second SSID and the second password.

6. The apparatus of claim 5, wherein the processor is further configured to:
scan access points to obtain the scan result including SSIDs of the access points;
determine whether the first SSID is present in the scan result; and
acquire the first SSID when the first SSID is present in the scan result.

7. The apparatus of claim 5, wherein the processor is further configured to:
send a request message to the second device for acquiring the second SSID and the second password of the wireless network; and
receive a response message from the second device, the response message including the second SSID and the second password of the wireless network.

8. The apparatus of claim 5, wherein the processor is further configured to:
receive the second SSID and the second password of the wireless network in a message generated by the second device.

9. A non-transitory computer-readable storage medium having stored therein instructions that, when executed by one or more processors of a first device, cause the first device to:
scan for a first service set identification (SSID);
acquire the first SSID from a scan result, wherein a second device corresponding to the first SSID is connected with the wireless network and provided with an activated relay function;
access the second device based on the first SSID and a first password of the second device;
acquiring a second SSID and a second password of the wireless network from the second device; and
accessing the wireless network based on the second SSID and the second password.
